(19) United States
(12) Patent Application Publication
(10) Pub. No.: US 2002/0099549 A1
(43) Pub. Date: Jul. 25, 2002

(54) Method for automatically presenting a digital presentation

(76) Inventor: Khang Kv. Nguyen, Garden Grove, CA (US)

Correspondence Address: Khang Kv Nguyen, 10852 Lampson Ave., Garden Grove, CA, 92840, US

(21) Appl. No.: 09/729,333

(22) Filed: Dec. 4, 2000

(51) Int. Cl. G10L 11/00

(52) U.S. Cl. 704/270

(57) ABSTRACT

A method for automatically presenting a digital presentation comprises at least one digital agent and a plurality of presentation slides in digital form. Receive an array of tags, which is a mixture of presentation tags, action tags, and speech tags. Move a cursor within said array from the first tag to the last tag in a serial and tag-by-tag manner. Interpret and process each tag that said cursor points to. Control the way said presentation slides are displayed, when one of said presentation tags gets processed. Control the way said digital agent acts, when one of said action tags gets processed. Control the way said digital agent speaks, when one of said speech tags gets processed. The method further allows a presentation to perform fast forwarding and fast rewinding.

### CROSS-REFERENCE TO RELATED APPLICATIONS

Not Applicable.

### STATEMENT REGARDING FEDERALLY SPONSORED RESEARCH AND DEVELOPMENT

Not Applicable.

### REFERENCE TO A MICROFICHE APPENDIX

Not Applicable.

### BACKGROUND OF THE INVENTION

1. Field of Invention

This invention relates to how to automatically present a digital presentation, and it especially applies to the use of presentation slides and text tags, all in digital forms. It also deploys at least one digital agent, which presents said presentation instead of a human being.

2. Description of Related Arts

Digital presentation technologies have been around for years. One typical and popular presentation program is PowerPoint of Microsoft. This software lets the users to create digital slides and to program on how the slides are to be displayed. But a PowerPoint presentation needs at least one human being to present the slides. In other words, the presentation needs at least one presenter to make a speech about the slides to an audience.

In a small conference room, a human presenter is a suitable speaker for the presentation. But when that presentation is transmitted via a network, especially the Internet, it is impossible to send the presenter to each client computer that is viewing the presentation. Furthermore, when the audience wants to see the presentation at random times, the presenter may not be available to make the speech. Hence, the traditional approach cannot show a presentation in all places and at all times.

U.S. Pat. No. 6,052,663 by Kurzweil, et al. (Apr. 18, 2000) allows a document image to be displayed properly on a computer and provides a text-to-speech engine to read texts to an audience. This patent, however, does not provide a complete presentation technology because it does not have a visual presenter, who can act and show emotions during a speech. Instead, the patent only provides a text-to-speech engine, which focuses more on the reading part than on the presenting part. Furthermore, the text-to-speech engine gets text inputs only from the document image (by using optical character recognition technology), and at the same time, the document image is used as the main presentation slide; hence, programming codes and text tags cannot be embedded inside the document image, because those codes and tags will be visible in the presentation. As the result, the presentation cannot perform complex tasks such as visual and time-based effects. Finally, extracting texts from the document image is an error-prone process, which reduces the accuracy of the presentation.

U.S. Pat. No. 6,115,686 by Chung, et al. (Sep. 5, 2000) and U.S. Pat. No. 6,085,161 by MacKenty, et al. (Jul. 4, 2000) also use text-to-speech engines as a way to deliver a document to an audience. However, these patents emphasize only on converting an HTML files into an audio presentation. So, they are not a complete solution for showing a digital presentation, because they ignore the graphical part.

Microsoft Corp. has a software product called MS Agent. When this software runs, it can display several cartoon-like characters such as Genie, Merlin, Peedy, and Robby. These characters are digital agents that can be programmed to speak and act on a monitor screen. Software developers have been using digital agents to add interactive features to software applications.

Digital agents can be programmed to replace human presenters in presenting a presentation. But in order to produce a presentation with digital agents, presentation writers must learn how to program those digital agents in an object-oriented language such as Visual Basic or Java. Furthermore, the presentation writers must also learn how to program the presentation software such as PowerPoint. This requirement of programming skills makes producing a presentation with digital agents an impossible task for most people.

In this patent application, I seek to show a new approach of presenting a digital presentation. This invention provides a complete presentation technology, because it provides at least one digital agent that can act and speak, a plurality of presentation slides, and a means to control the digital agent as well as the display of the presentation slides. Moreover, this invention eliminates all programming skill requirements in constructing and playing the presentation.

### SUMMARY OF THE INVENTION

A method for automatically presenting a digital presentation comprises at least one digital agent and a plurality of presentation slides in digital form. Receive an array of tags, which is a mixture of presentation tags, action tags, and speech tags. Move a cursor within said array from the first tag to the last tag in a serial and tag-by-tag manner. Interpret and process each tag that said cursor points to. Control the way said presentation slides are displayed, when one of said presentation tags gets processed. Control the way said digital agent acts, when one of said action tags gets processed. Control the way said digital agent speaks, when one of said speech tags gets processed.

Whereby, a presentation writer can construct said digital slides and write said array of tags; an application of the present invention will interpret and process those tags; the application will follow the instructions of the tags to control the speech and action of the digital agent as well as to present those digital slides properly; and said digital agent will play the role of a presenter during said presentation.

The method further allows said presentation to perform fast forwarding and fast rewinding by pointing said cursor to a certain tag within said array. Evaluate all previous tags which stand before said certain tag. Ignore those of said previous tags that do not contribute to how said presentation looks at said certain tag. Process in an expedited manner those of said previous tags that contribute to how said presentation looks at said certain tag.

Whereby, said presentation can be fast forwarded or fast rewound to any point during the presentation, and the look of the presentation at that point is updated properly in an expedited manner.

Objects and Advantages

Several objects and advantages of the present invention are:

(a) to show a digital presentation without using a human being as a presenter; instead, a digital agent is used; therefore, the presentation can be transmitted via a network and played in any place and at any time;

(b) to use an array of tags to control the presentation; hence, the presentation can be programmed so that it can perform complex tasks such as visual and time-based effects:

(c) to interpret and process the tags; as the result, this invention does not require presentation writers to do programming in object-oriented languages such as Visual Basic or Java. Instead, applications that uses this invention will include all the necessary programming codes and will make available to the presentation writers a set of useable tags. The presentation writers only need to know those tags to control everything, from the display of the slides to the action and speech of the digital agent;

(d) to use tags so that the contents of a presentation can be updated easily. Updating the contents of a presentation means updating the slides and the tags. Since tags are similar to human language, updating tags is as easy as typing a simple document. On the other hand, if a presentation were constructed by programming codes, updating the presentation would mean updating the codes, which is a very complicated process that involves coding and debugging at computer language level;

(e) to control the digital agent's action and speech as well as the display of digital slides, so that a presentation can have all necessary elements for a good presentation—namely, graphics, audio, and presenting performance.

### DRAWING FIGURES

Not Applicable.

### LIST OF REFERENCE NUMERALS IN DRAWINGS

Not Applicable.

### DETAILED DESCRIPTION OF THE INVENTION

The invention is a method for automatically presenting a digital presentation.

The method uses at least one digital agent. A digital agent is a software program that can play animations, sounds, and voices that reflect human behaviors such as speaking, acting, and emoting. Microsoft has a software called MS Agent, which can play four digital agents named Genie, Merlin, Peedy, and Robby. In this description, I shall use two agents Genie and Merlin as an example.

The method uses a plurality of digital slides, which can be a group of images or HTML files or document files. In this description, as an example, I shall use three slides, which are image1.gif, image2.gif, and image3.gif.

An array of tags needs to be supplied. I can use a text editor to write the tags. Following is an example array of tags:

| | |
|---|---|
| 01 | <agent>Genie |
| 02 | <agent-show> |
| 03 | <agent-goto>200, 100 |
| 04 | <agent-speak>Hello, world! This is the first slide. |
| 05 | <slide-show>image1.gif |
| 06 | <wait>10 seconds |
| 07 | <agent>Merlin |
| 08 | <agent-show> |
| 09 | <agent-goto>400, 100 |
| 10 | <agent-speak>Hi. And this is the second slide. |
| 11 | <slide-hide>image1.gif |
| 12 | <slide-show>image2.gif |
| 13 | <wait>10 seconds |
| 14 | <agent>Genie |
| 15 | <agent-hide> |
| 16 | <agent>Merlin |
| 17 | <agent-speak>And finally, this is the third slide. |
| 18 | <slide-hide>image2.gif |
| 19 | <slide-show>image3.gif |
| 20 | <wait>20 seconds |
| 21 | <agent-speak>This is the end of our presentation. |
| 22 | <agent-yell>Thank you very much! |
| 23 | <agent-hide> |

The text above can be considered an array of tags. Each element in that array is one line, and each element is a tag which opens with<and closes with>.

A cursor will move from tag 01 to the end of the presentation, which is tag 23. The cursor moves in a serial and tag-by-tag manner. When the cursor points to a tag, that tag is interpreted and processed.

In the example, when tag 01 is processed, agent Genie is selected. When tag 02 is processed, agent Genie is made to show, so that audience can see the digital agent on the monitor screen. At tag 03, agent Genie is made to move to the point x200, y100 on the monitor screen. At tag 04, agent Genie is made to speak “Hello, world! This is the first slide.” At tag 05, the slide image1.gif is displayed on the monitor screen. Tag 06 makes the computer to wait for 10 seconds, before the cursor moves to the next tag.

In general, the tags are grouped into three groups—presentation tags, action tags, and speech tags. When a presentation tag is processed, the display of the digital slides is affected. For example, when tag 05 is processed, the slide image1.gif is showed; and at tag 11, the slide image1.gif is hidden.

When an action tag is processed, the action of the digital agents is affected. For example, when tag 02 is processed, agent Genie is made to show itself on the monitor screen; and at tag 03, agent Genie moves in animation to the point (200,100).

When a speech tag is processed, the speech of the digital agents is affected. For example, when tag 04 is processed, agent Genie is prompted to speak “Hello, world! This is the first slide.” At tag 22, agent Merlin is prompted to yell, “Thank you very much!!”

The invention allows a presentation to do fast forwarding and fast rewinding. For instance when the example presentation is played to tag 06, the audience wants to skip five tags and to move the cursor directly to tag 12. This is fast forwarding, and the audience is allowed to do that. The skipped tags 07, 08, 09, 10, and 11 are not all ignored, however, because the presentation status at tag 12 is directly influenced by some of the skipped tags.

Suppose the audience had not skipped from tag 06 to tag 12. At tag 07, agent Merlin would have been selected. At tag 08, agent Merlin would have showed. At tag 09, agent Merlin would have moved to the point (400, 100). At tag 10, agent Merlin would have said, “Hi. And this is the second slide.” At tag 11, the slide image1.gif would have been hidden. This particular point would have been the presentation status, when the cursor moved to tag 12.

Therefore, when the audience fast forwarded from tag 06 to tag 12, all skipped tags are evaluated. Only those of the skipped tags that do not have a direct impact on the presentation status at tag 12 will be ignored. For example, tag 10 will be ignored, because it does not contribute to how the presentation looks at tag 12.

Those of the skipped tags that have a direct impact on the presentation at tag 12 will be processed in an expedited manner. For example, tags 07, 08, 09, and 11 must be processed, because at tag 12 the audience expects to see agent Merlin at point (400, 100) and the slide image1.gif hidden. However, tag 09 would require a lengthy execution, which would animate agent Merlin to the point (400, 100); and hence, tag 09 will be processed in an expedited manner—that is, the animation will be rid of, and agent Merlin will simply be prompted to jump to point (400, 100). The audience expects such an expedited execution, when he or she does fast forwarding or fast rewinding.

Description of Alternative Embodiments

Not Applicable.

Conclusion, Ramifications, and Scope

The invention is a method for automatically presenting a digital presentation. From the description above, a number of advantages of my method become evident:

(a) The showing of the presentation does not need a human being as a presenter. By using digital agents, the method allows the presentation to be transmitted via a network and played in any place and at any time.

(b) The method controls the showing of the presentation by an array of tags. Hence, the presentation can be programmed to do complex tasks such as visual and time-based effects.

(c) The use of tags does not require presentation writers to learn a programming language. Writing and updating tags are much easier than writing and updating programming codes. In other words, the use of tags make the presentation flexible and powerful yet simple.

(d) The invention offers a complete presentation technology that embraces three main areas: graphics, audio, and presenting performance.

Although the description above contains several specifications, these should not be construed as limiting the scope of the invention but as merely providing illustrations of some applications of the invention. For example, the presentation slides can be in other formats such as HTML.

Thus the scope of the invention should be determined by the appended claims and their legal equivalents, rather than by the examples given.

I claim:

1. A method for automatically presenting a digital presentation, comprising
a. providing at least one digital agent, which is a software program that can play animations, sounds, and voices that reflect human behaviors such as speaking, acting, and emoting,
b. providing a plurality of presentation slides in digital form,
c. receiving an array of tags, which is a mixture of presentation tags, action tags, and speech tags,
d. moving a cursor within said array from the first tag to the last tag in a serial and tag-by-tag manner,
e. interpreting and processing each tag that said cursor points to, following these rules:
(i) controlling the way said presentation slides are displayed, when one of said presentation tags gets processed,
(ii) controlling the way said digital agent acts, when one of said action tags gets processed,
(iii) controlling the way said digital agent speaks, when one of said speech tags gets processed.

2. A method of claim 1, further comprising
a. pointing said cursor to a certain tag within said array,
b. evaluating all previous tags which stand before said certain tag,
c. ignoring those of said previous tags that do not contribute to how said presentation looks at said certain tag,
d. processing in an expedited manner those of said previous tags that contribute to how said presentation looks at said certain tag.
